(19) United States
(12) Patent Application Publication
(10) Pub. No.: US 2010/0012669 A1
(43) Pub. Date: Jan. 21, 2010

(54) Panels for a Container Joint Including a Three Dimensional Pattern on a Portion Thereof and Methods of Forming Same

(75) Inventor: Bryan Carl Anderson, Jonesboro, AR (US)

Correspondence Address: MYERS BIGEL SIBLEY & SAJOVEC, PO BOX 37428, RALEIGH, NC, 27627, US

(73) Assignee: Delta Consolidated Industries

(21) Appl. No.: 12/173,377

(22) Filed: Jul. 15, 2008

(51) Int. Cl. B65D 6/02; B30B 13/00

(52) U.S. Cl. 220/674; 100/35

(57) ABSTRACT

A panel member has a three dimensional pattern thereon, and the panel member is shaped using a die having at least one substantially smooth side. A portion of the panel member having the three dimensional pattern thereon is pressed adjacent the substantially smooth side of the die with a force sufficient to reshape the portion of the panel member so that the portion of the panel member has a major surface that is substantially void of the three dimensional pattern. The shaping and pressing are performed in a single pressing step.

### FIELD OF THE INVENTION

The present invention relates to storage containers, and in particular to storage containers formed of sheet metal with joints between sheets.

### BACKGROUND

Large storage containers, including boxes and cabinets, used in the construction industry are often formed of sheet metal. The floor, walls and ceiling (or lid) of the container can be formed either from a single sheet of metal that is bent at intersecting edges of these surfaces or from multiple pieces of sheet metal that are welded or adhered together at a joint.

The sheet metal can include a three dimensional pattern, such as a raised tread pattern. Although the tread pattern can be desirable in order to strengthen and structurally reinforce the metal panels for a construction box, the tread pattern can present difficulties when joints are formed. In particular, the sheet metal is typically bent to form a contact area or flange portion for a joint between adjacent pieces of sheet metal. However, the tread pattern is typically formed on the entire panel, and, therefore, the contact area or flange portion includes the raised tread pattern. The tread pattern in the contact area of the joint can prevent a close fit between the adjacent metal panels.

### SUMMARY OF EMBODIMENTS OF THE INVENTION

According to some embodiments of the present invention, methods of forming a panel member having a three dimensional pattern thereon are provided. The panel member is shaped using a die having at least one substantially smooth side. A portion of the panel member having the three dimensional pattern thereon is pressed adjacent the substantially smooth side of the die with a force sufficient to reshape the portion of the panel member so that the portion of the panel member has a major surface that is substantially void of the three dimensional pattern. The shaping and pressing are performed in a single pressing step.

In some embodiments, shaping the panel member includes bending the panel member to form a crook. After pressing a portion of the panel member adjacent the substantially smooth side of the die, the crook is between the portion of the panel member that is substantially void of the three dimensional pattern and another portion of the panel member that includes the three dimensional pattern. In some embodiments, the substantially smooth side of the die is substantially planar.

In particular embodiments, the three dimensional pattern includes a raised, tread pattern on a substantially planar surface. The three dimensional pattern may be configured to structurally reinforce the panel member. The panel member can be formed of a single sheet of metal.

In some embodiments, methods of forming a joint in a container using a first panel member having a three dimensional pattern thereon are provided. The first panel member is shaped using a die having at least one substantially smooth side. A portion of the first panel member having the three dimensional pattern thereon is shaped adjacent the substantially smooth side of the die with a force sufficient to reshape the portion of the first panel member so that the portion of the first panel member has a major surface that is substantially void of the three dimensional pattern. An abutment between the major surface of the portion of the first panel member that is substantially void of the three dimensional pattern and a second, cooperating panel member forms a joint.

Forming the joint can include applying an adhesive between the major surfaces of the first and second panel members, fastening the second panel member to the portion of the first panel member, and/or welding the second panel member to the portion of the first panel member.

According to further embodiments of the invention, a container includes a first, unitary panel member having first and second portions and a crook therebetween. The first portion has a three dimensional pattern thereon and the second portion has a major surface that is substantially void of the three dimensional pattern. A second panel member has a major surface generally corresponding to the major surface of the first panel second portion. A joint includes an abutment between the major surfaces of the first panel member second portion and the second panel member.

According to further embodiments of the present invention, a unitary panel for forming a container includes first and second panel portions and a crook therebetween. The first portion has a three dimensional pattern thereon and the second portion is substantially void of the three dimensional pattern and configured to provide a joint contact area for a joint in a container.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a side view of a die assembly and panel member according to embodiments of the present invention.

FIG. 2 is a side view of the die assembly and panel member of FIG. 1 as a top portion of the die assembly is lowered onto the panel member.

FIG. 3A is a side view of the die assembly and panel member of FIG. 1 as the die assembly shapes the panel member;

FIG. 3B is an enlarged side view of the die assembly and panel member of FIG. 3A.

FIG. 4A is a side view of the die assembly and panel member of FIG. 1 as the die assembly presses the panel member to reduce the three dimensional pattern on a portion thereof.

FIG. 4B is an enlarged side view of the die assembly and panel member of FIG. 4A.

FIG. 5 is a flowchart illustrating operations according to embodiments of the present invention.

FIG. 6 is a front perspective view of a panel member each having a three dimensionally patterned portion and another portion that is substantially void of the three dimensional pattern according to embodiments of the present invention.

FIG. 7 is a back perspective view of the panel member of FIG. 6.

FIG. 8 is a perspective, exploded view of a container that includes multiple joints of FIG. 7.

FIG. 9 is a perspective, assembled view of the container of FIG. 8.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps), for example, with reference to block diagrams and/or flow chart illustrations, is not limited to the order presented in the claims or figures unless specifically indicated otherwise.

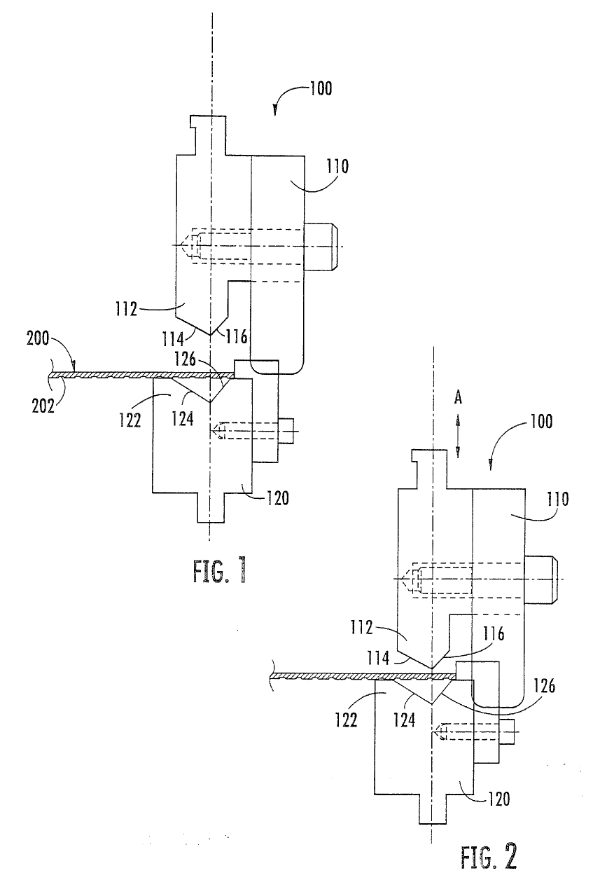

As shown in FIGS. 1-2, 3A-3B and 4A-4B, a die assembly 100 includes a top portion 110 and a bottom portion 120. The top portion 110 includes a forming die 112 with two sides 114, 116, and the bottom portion 120 includes a corresponding forming die 122 with two sides 124, 126. As illustrated, the side 126 has a substantially smooth surface. As shown in FIG. 1, a panel 200 including a three dimensional pattern 202 (such as a tread pattern) is positioned between the top portion 110 and the bottom portion 120 of the die assembly 100. The top portion 110 of the die assembly 100 is movable along an axis A with respect to the bottom portion 120 (FIG. 2).

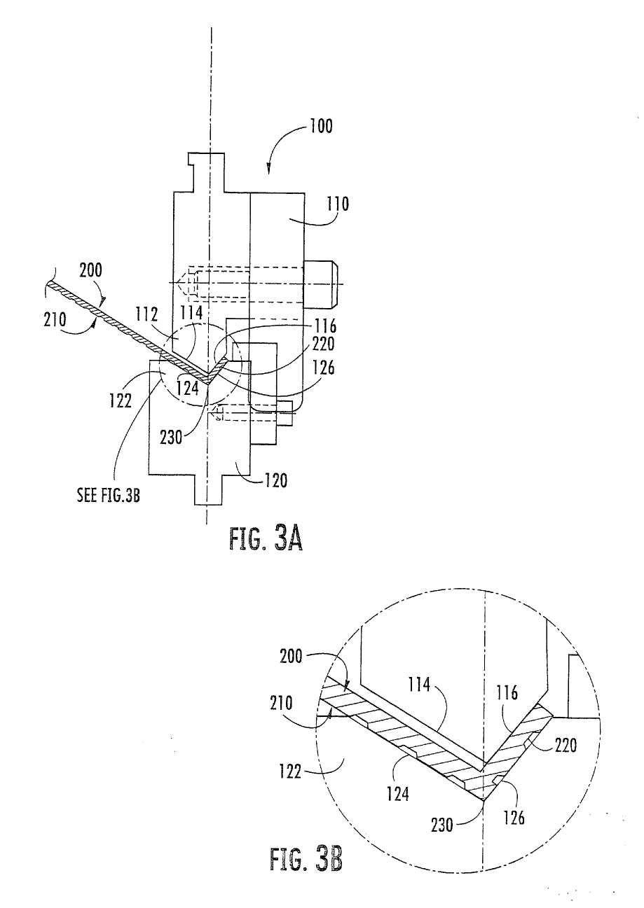

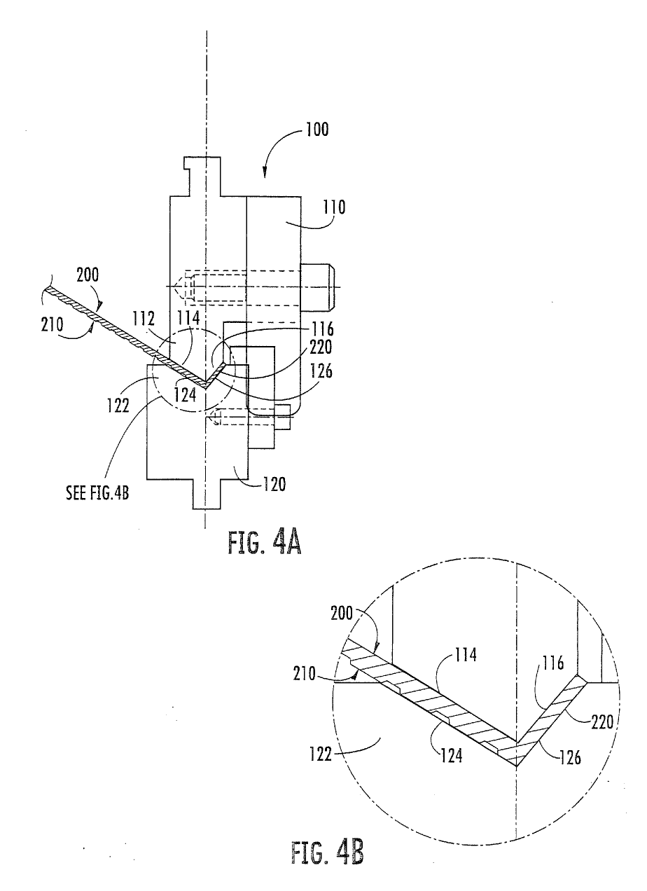

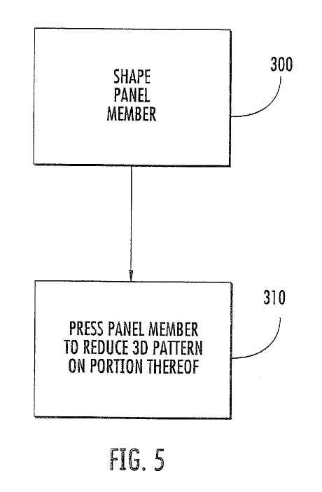

With reference to FIGS. 1-2, 3A-3B, 4A-4B and 5, the panel 200 is shaped by the die assembly (FIG. 5, Block 300). As shown in FIGS. 3A-3B, the top portion forming die 112 of the die assembly 100 presses the panel 200 into the bottom portion forming die 122. As a result, the panel 200 includes two portions 210, 220 and a crook 230 therebetween. As shown in FIGS. 4A-4B, the panel 200 is further pressed between the forming die 112, 122 with a force that is sufficient to reshape the portion 220 of the panel 200 so that the portion 220 is substantially void or free of the three dimensional pattern (FIG. 5, Block 310). In particular embodiments, the steps of shaping the panel 200 (FIGS. 3A-3B; FIG. 5, Block 300) and pressing the portion 220 to reduce or remove the three dimensional pattern (FIGS. 4A-4B; FIG. 5, Block 310) are performed substantially simultaneously and/or with one generally continuous motion, e.g., of the top portion 110 of the die assembly 100.

As shown in FIG. 4A-4B, the die assembly 100 is configured such that, in operation, the sides 114, 124 provide sufficient clearance for the pattern 202 of the panel 200 so that the pattern 202 is substantially preserved on the panel portion 210. However, the sides 116, 126 are configured to have a close fit such that, in the closed position shown in FIG. 4A-4B, the pattern 202 of the panel is flattened and substantially removed from the panel portion 220.

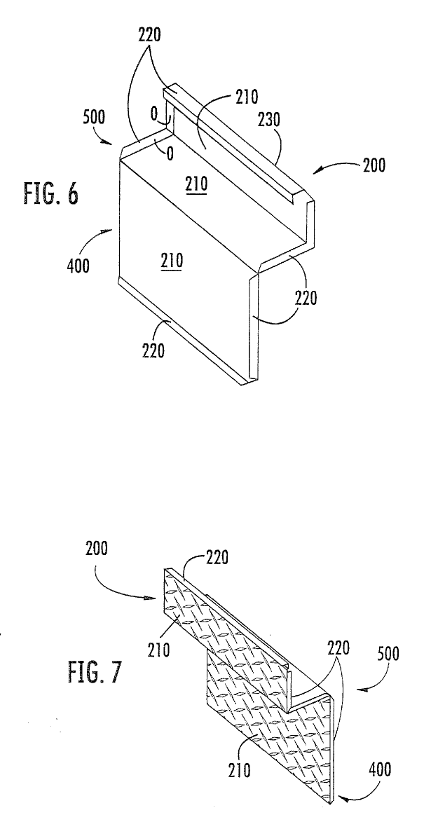

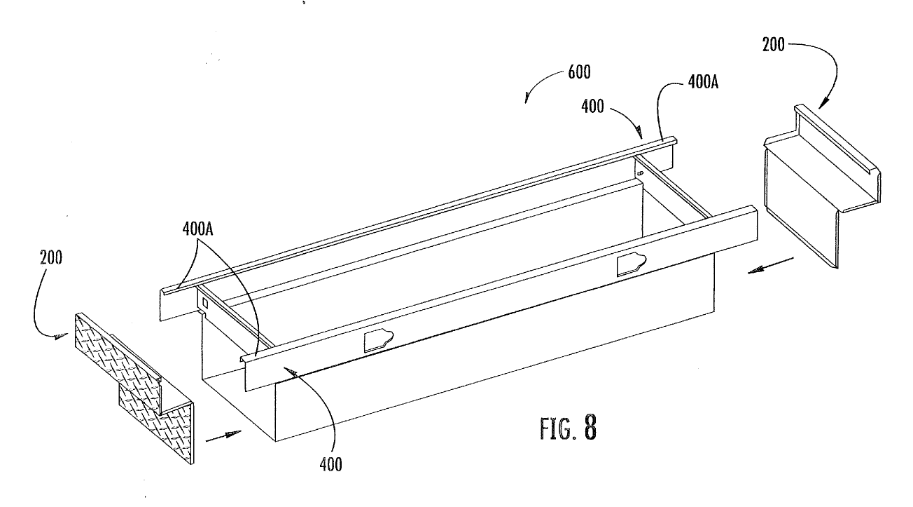

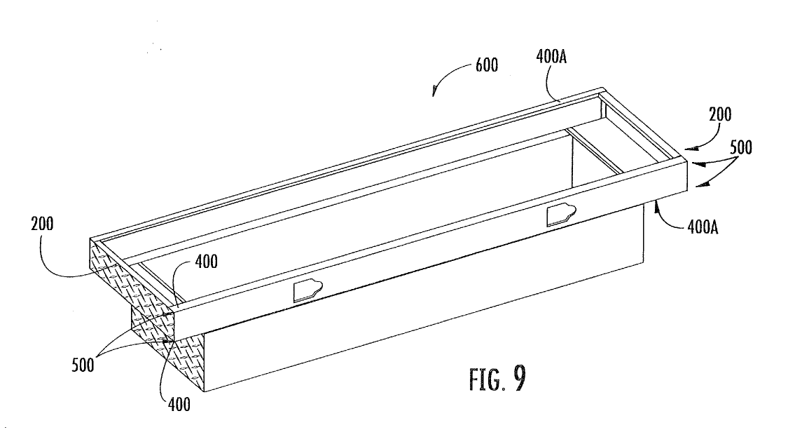

As illustrated in FIGS. 6 and 7, the resulting panel 200 includes portions 210 that have the three dimensional pattern thereon, and other portions 220 that have been pressed or flattened such that the portions 220 are substantially void of the three dimensional pattern. A flange bend or crook 230 is located between the portions 210, 220 and forms an angle θ, e.g., of about 90 degrees. As further illustrated in FIGS. 8 and 9, the substantially smooth portion 220 can be used to form a flange for a joint 500 with another panel 400 having flange portions 400A that are configured to mate with the smooth portions 220. As illustrated, the panel 400 does not include the three dimensional pattern and is formed by bending substantially flat sheet metal. However, in some embodiments, the panel 400 can be formed using the process described with respect to FIGS. 1-2, 3A-3B,4A-4B and 5 such that the panel 400 could include both substantially flat portions (e.g., such that the flange portion 400A are substantially void of a three dimensional pattern) and other portions having a three dimensional pattern 402 thereon. As illustrated, the panel 200 is formed of a unitary member, such as a single sheet of metal. In some embodiments, the metal sheet can have a thickness of 0.125 inches and the three dimensional pattern can extend about 0.050 inches from the planar portion of the panel. The metal can be formed of steel.

As illustrated in FIGS. 8 and 9, the joints 500 are an abutment between the major surfaces of the panel portion 210 and the flange portion 400A. The portions 220, 400A can be connected by welding, by an adhesive or by a fastener, such as a screw or bolt. As shown in FIGS. 8 and 9, the panels 200 can be used to form a side of a container 600, such as a large storage container or construction box.

In this configuration, a panel 200 having a three dimensional pattern 202 thereon and including a portion 220 that is substantially void of the pattern can be formed from a single, unitary panel (such as a pre-patterned metal sheet). A single die assembly, such as the die assembly 100, can be used to form the panel 200, e.g., in a single, continuous motion for ease of manufacturing. The panel 200 can be used to form a joint with an adjacent panel in a container. In particular, the panel portion 210 that includes the pattern 202 may be used to provide a side of a wall or other portion of a container in which structural reinforcement from the three dimensional pattern may be desirable. The panel portion 220 can provide a relatively smooth contact area or flange for another panel (such as the panel portion 400A).

As illustrated in FIGS. 1-2, 3A-3B, 4A-4B and 6-9, the substantially smooth portions 220 can be substantially planar. However, it should be understood that alternative die shapes and resulting panel shapes can be used without departing from the scope of the current invention. For example, the smooth portions 220 can be curved or bent in any suitable shape. In addition, the angle θ shown in FIGS. 6 and 7 is about 90 degrees; however, other angles can be used between the patterned portion 210 and the smooth portion 220, for example, depending on the desired shape of the container 600. It should also be understood that joints formed as described herein can be used in various container configurations including the container 600 shown in FIG. 8.

Although the top portion 110 of the die assembly 100 is illustrated as being movable along an axis A, it should be understood that other die assembly configurations can be used. For example, the top portion 110 and/or the bottom portion 120 of the die assembly 100 can be movable with respect to one another. In some embodiments, the die assembly 100 (e.g., the top portion 110) can be configured to exert pressure that is sufficient to remove the three dimensional pattern from the portion 220 of the panel 200 without removing the pattern from the portion 210. Stated otherwise, the die assembly 100 can be configured to exert more pressure on the panel 200 between the sides 116, 126 by spacing the sides 116, 126 sufficiently close together in the closed position of FIGS. 4A-4B to flatten the portion 220 of the panel 200. For example, the sides 114, 116, 124, 126 can be configured to provide additional clearance or space between the sides 114, 124 and a closer fit between the sides 116, 126 in the closed position. In particular embodiments, the movable portion (e.g., the top portion 110 as illustrated in FIGS. 1-2, 3A-3B and 4A-4B) can be configured to move away from the direction of the axis A and in a direction toward the side 126 of the bottom portion 120 to thereby exert additional pressure between the sides 116, 126 of the die assembly 100.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of forming a panel member, the panel member having a three dimensional pattern thereon, the method comprising:
shaping the panel member using a die having at least one substantially smooth side; and
pressing a portion of the panel member having the three dimensional pattern thereon adjacent the substantially smooth side of the die with a force sufficient to reshape the portion of the panel member so that the portion of the panel member has a major surface that is substantially void of the three dimensional pattern, wherein the shaping and pressing are performed in a single step.

2. The method of claim 1, wherein shaping the panel member comprises bending the panel member to form a crook, and wherein after pressing a portion of the panel member adjacent the substantially smooth side of the die, the crook is between the portion of the panel member that is substantially void of the three dimensional pattern and another portion of the panel member that includes the three dimensional pattern.

3. The method of claim 1, wherein the substantially smooth side of the die is substantially planar.

4. The method of claim 1, wherein the three dimensional pattern comprises a raised, tread pattern on a substantially planar surface.

5. The method of claim 1, wherein the three dimensional pattern is configured to structurally reinforce the panel member.

6. The method of claim 1, wherein the panel member is formed of a single sheet of metal.

7. The method of claim 1, wherein pressing the portion of the panel member is performed with a force sufficient to flatten the portion of the panel member.

8. A method of forming a joint in a container using a first panel member having a three dimensional pattern thereon, the method comprising:
shaping the first panel member using a die having at least one substantially smooth side; and
pressing a portion of the first panel member having the three dimensional pattern thereon adjacent the substantially smooth side of the die with a force sufficient to reshape the portion of the first panel member so that the portion of the first panel member has a major surface that is substantially void of the three dimensional pattern;
wherein an abutment between the major surface of the portion of the first panel member that is substantially void of the three dimensional pattern and a second, cooperating panel member forms a joint.

9. The method of claim 8, wherein forming the joint comprises applying an adhesive between the major surfaces of the first and second panel members.

10. The method of claim 8, wherein forming the joint comprises fastening the second panel member to the portion of the first panel member.

11. The method of claim 8, wherein forming the joint comprises welding the second panel member to the portion of the first panel member.

12. The method of claim 8, wherein the three dimensional pattern comprises a raised, tread pattern on a substantially planar surface.

13. The method of claim 8, wherein the three dimensional pattern is configured to structurally reinforce the panel member.

14. The method of claim 8, further comprising forming the panel member of a single sheet of metal.

15. A container comprising:
a first, unitary panel member having first and second portions and a crook therebetween, the first portion having a three dimensional pattern thereon and the second portion having a major surface that is substantially void of the three dimensional pattern;
a second panel member having a major surface generally corresponding to the major surface of the first panel second portion; and
a joint comprising an abutment between the major surfaces of the first panel member second portion and the second panel member.

16. The container of claim 15, wherein the second panel member comprises a unitary piece having first and second portions and a crook therebetween, the second panel member first portion having a three dimensional pattern thereon and the second panel second portion comprising being substantially void of the three dimensional pattern.

17. The container of claim 15, further comprising an adhesive between the major surfaces of the first panel member second portion and the second panel member.

18. The container of claim 15, further comprising a fastener connecting the major surfaces of the first panel member second portion and the second panel member.

19. The container of claim 15, wherein the major surface of the first panel member second portion is welded to the major surface of the second panel member.

20. The container of claim 15, wherein the three dimensional pattern comprises a raised, tread pattern on a substantially planar surface.

21. The container of claim 15, wherein the three dimensional pattern is configured to structurally reinforce the panel member.

22. The container of claim 15, wherein the first, unitary panel member is formed of a single sheet of metal.

23. The container of claim 15, wherein the major surface of the first panel member second portion and the major surface of the second panel member are substantially planar.

24. A unitary panel for forming a joint in a container, the panel comprising:
first and second panel portions and a crook therebetween, the first portion having a three dimensional pattern thereon and the second portion being substantially void of the three dimensional pattern and configured to provide a joint contact area for a joint in a container.
